(19) United States
(12) Patent Application Publication
(10) Pub. No.: US 2026/0045699 A1
(43) Pub. Date: Feb. 12, 2026

(54) ANTENNA DEVICE

(71) Applicant: MICROELECTRONICS TECHNOLOGY, INC., HSINCHU (TW)

(72) Inventor: Sheng Yuan WANG, HSINCHU (TW)

(21) Appl. No.: 18/795,825

(22) Filed: Aug. 6, 2024

(51) Int. Cl. H01Q 9/04

(52) U.S. Cl. CPC H01Q 9/0414; H01Q 9/045

(57) ABSTRACT

The present disclosure provides an antenna device configured to transmit an output radio wave to other electronic device. The antenna device includes a stacked structure and a top printed circuit board. The stacked structure includes first radiators. The first radiators are configured to radiate an intermediate radio wave, and disposed on a top surface of the stacked structure. The top printed circuit board includes second radiators. The second radiators are configured to receive the intermediate radio wave and radiate the output radio wave according to the intermediate radio wave, and disposed on a bottom surface of the top printed circuit board. The bottom surface of the top printed circuit board is facing the top surface of the stacked structure.

### TECHNICAL FIELD

The present disclosure relates to an antenna device, and more particularly, to an antenna device without a traditional radome.

### DISCUSSION OF THE BACKGROUND

The antenna is an important device in wireless communication. In order to achieve a desired bandwidth of the radio wave, there are more printed circuit boards implemented in the antenna. In addition, the radome has to be re-designed to cope with the radio wave. The extra printed circuit boards and the re-designed radome also pull up the overall cost of the antenna and the increase the dimension of the antenna. Therefore, trade-off between the cost, the dimension, and the performance becomes a critical issue in this field.

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides an antenna device configured to transmit an output radio wave to other electronic device. The antenna device includes a stacked structure and a top printed circuit board. The stacked structure includes first radiators. The first radiators are configured to radiate an intermediate radio wave, and disposed on a top surface of the stacked structure. The top printed circuit board includes second radiators. The second radiators are configured to receive the intermediate radio wave and radiate the output radio wave according to the intermediate radio wave, and disposed on a bottom surface of the top printed circuit board. The bottom surface of the top printed circuit board is facing the top surface of the stacked structure.

In some embodiments, the antenna device further includes a metal frame, which is disposed between the stacked structure and the top printed circuit board. The metal frame includes through holes.

In some embodiments, the metal frame is in contact with the top surface of the stacked structure and the bottom surface of the top printed circuit board. Each of the through holes exposes one of the first radiators and one of the second radiators.

In some embodiments, the intermediate radio wave is transmitted from the first radiators to the second radiators through the through holes.

In some embodiments, the metal frame is free in contact with the first radiators and the second radiators.

In some embodiments, the through holes are arranged as an array from a top view.

In some embodiments, each of the through holes is a hexagon from a top view.

In some embodiments, a diameter of each of the through holes is equal to half of a wavelength of the output radio wave transmitted in the top printed circuit board.

In some embodiments, a pitch between two nearest through holes is about 0.48 times of a wavelength of the intermediate radio wave transmitted in free space.

In some embodiments, a thickness of the metal frame is about 0.8 mm.

In some embodiments, the stacked structure includes printed circuit boards stacked disposed. Each of the printed circuit boards has a thickness substantially the same to each other.

Another aspect of the present disclosure provides an antenna device configured to transmit an output radio wave to other electronic device. The antenna device includes a stacked structure, a metal frame, and a top printed circuit board. The stacked structure is configured to radiate an intermediate radio wave. The metal frame is disposed on and in contact with a top surface of the stacked structure. The top printed circuit board is in contact with the metal frame and opposite to the stacked structure, and configured to receive the intermediate radio wave and radiate the output radio wave according to the intermediate radio wave.

In some embodiments, the metal frame includes through holes. The intermediate radio wave is transmitted from the stacked structure to the top printed circuit board through the through holes.

In some embodiments, the stacked structure includes first radiators. The first radiators are disposed on the top surface of the stacked structure and configured to radiate the intermediate radio wave.

In some embodiments, the top printed circuit board includes second radiator. The second radiator are disposed on a bottom surface of the top printed circuit board configured to receive the intermediate radio wave so as to radiate the output radio wave. The bottom surface of the top printed circuit board is in contact with the metal frame.

In some embodiments, the through holes expose the first radiators and the second radiators, and the first radiators and the second radiators are free in contact with the metal frame.

In some embodiments, each of the through holes is circle from a top view.

In some embodiments, each of the through holes is hexagon from a top view.

In some embodiments, the stacked structure comprises 14 layers of printed circuit boards stacked disposed

In some embodiments, the metal frame includes aluminum.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIG. 1 is a schematic diagram of an antenna device according to some embodiments of the present disclosure.

FIG. 2 is a schematic diagram of a top printed circuit board, a metal frame, and a stacked structure from a top view according to some embodiments of the present disclosure.

FIG. 3 is a schematic diagram of a top printed circuit board, a metal frame, and a stacked structure from a bottom view according to some embodiments of the present disclosure.

FIG. 4 is a schematic diagram of through holes of a metal frame according to some embodiments of the present disclosure.

FIG. 5 is schematic diagrams of a top printed circuit board from a bottom view, and a metal frame and a stacked structure from a top view and according to some embodiments of the present disclosure.

FIG. 6 is a schematic diagram of a stacked structure according to some embodiments of the present disclosure.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, components, regions, layers or sections, these elements, components, regions, layers or sections are not limited by these terms. Rather, these terms are merely used to distinguish one element, component, region, layer or section from another element, component, region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limiting to the present inventive concept. As used herein, the singular forms “a,” “an” and “the” are intended to include the plural forms as well, unless the context clearly indicates otherwise. It shall be further understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

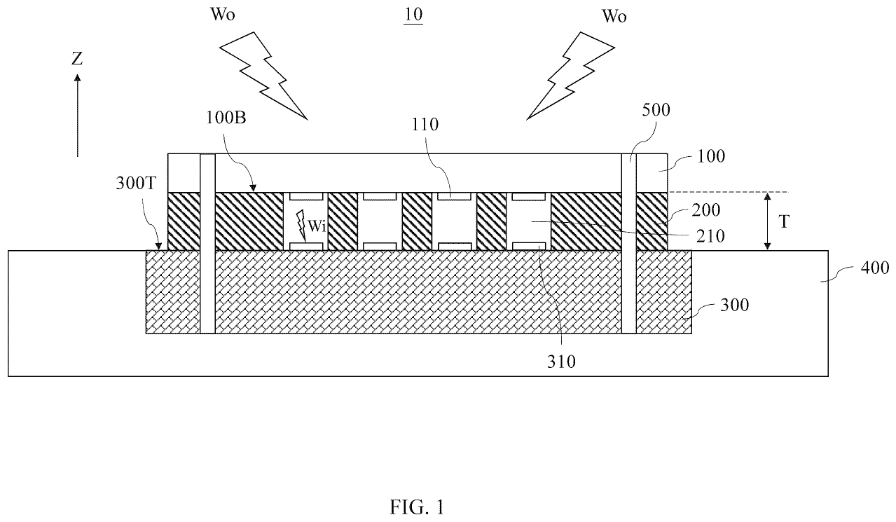

FIG. 1 is a schematic diagram of an antenna device 10 according to some embodiments of the present disclosure. The antenna device 10 is configured to transmit an output radio wave Wo to other electronic device (not shown). It should be noted that the antenna device is able to transmit and receive the radio wave. In other words, the antenna device 10 is further configured to receive a radio wave from external transmitter. However, for the sake of brevity, the antenna device 10 is described according to the transmitting function, and the receiving function is omitted in the present disclosure.

In some embodiments, the antenna device 10 is able to be operated in a range from about 24.25 GHz to about 27.5 GHz. In some embodiments, the gain of the output radio wave Wo within the range of 24.25 GHz to 27.5 GHz is sufficient to support the requirements of the antenna device 10. Furthermore, a maximum difference between the gains of main peak of TX mode of the output radio wave Wo at 25 GHz, 26 GHz, and 27 GHz is less than 4.2 dB. In some embodiments, a bandwidth of the output radio wave Wo is about 3.25 GHz.

The antenna device 10 includes a top printed circuit board 100, a metal frame 200, a stacked structure 300, and a housing 400.

The stacked structure 300 is mounted in the housing 400. The metal frame 200 is disposed on the stacked structure 300. The top printed circuit board 100 is disposed on the metal frame 200. In some embodiments, the antenna device 10 further includes fixtures 500. The fixtures 500 penetrate the top printed circuit board 100, the metal frame 200, and the stacked structure 300, and is configured to fixate the top printed circuit board 100 and the metal frame 200 on the stacked structure 300. In some embodiments, the fixtures 500 are screws. In some embodiments, the fixtures 500 are made of metal. In other embodiments, the fixtures 500 are made of plastic.

As illustrated in FIG. 1, the metal frame 200 is in contact with a top surface 300T of the stacked structure 300, and the top printed circuit board 100 is in contact with the metal frame 200 and opposite to the stacked structure 300. A bottom surface 100B of the top printed circuit board 100 is facing the stacked structure 300 and in contact with the metal frame 200. In some embodiments, a thickness T of the metal frame 200 is about 0.8 mm. In some embodiments, a thickness of the top printed circuit board 100 is about 17±0.8 mils (≈0.4318±0.0203 mm)

The stacked structure 300 is a phased array antenna module (PAAM) and includes printed circuit boards stacked disposed. The stacked structure 300 is configured to radiate an intermediate radio wave Wi. In some embodiments, the stacked structure 300 has beamforming integrated circuits, a driver, an up/down converter, a feeding network, a phase-locked loop, a digital signal control and memory module, a power supply, and a heat dissipation, and the above elements are integrated in the printed circuit boards of the stacked structure 300. It should be noted that the stacked structure 300 is not limited to include the aforementioned elements, any configurations which can be operated as a PAAM are within the contemplated scope of the present disclosure.

The stacked structure 300 further includes radiators 310 disposed on the top surface 300T of the stacked structure 300. The radiators 310 are configured to radiate the intermediate radio wave Wi. In some embodiments, the radiators 310 includes metal. In some embodiments, the radiators 310 are metal pads.

The metal frame 200 includes through holes 210. Each through hole 210 is extended from the bottom surface 100B of the top printed circuit board 100 to the top surface 300T of the stacked structure 300. In some embodiments, the through holes 210 are identical to each other. As shown in FIG. 1, because the through hole 210 respectively exposes the radiators 310, the metal frame 200 is not in contact with the radiators 310. The intermediate radio wave Wi is transmitted in the through holes 210.

In some embodiments, the metal frame 200 includes aluminum. In some embodiments, the metal frame 200 is monolithic.

The top printed circuit board 100 includes radiators 110 disposed on the bottom surface 100B of the top printed circuit board 100. The radiators 110 are exposed by the through holes 210, respectively. The metal frame 200 is not in contact with the radiators 110. In some embodiments, the radiators 110 includes metal. In some embodiments, the radiators 110 are metal pads. In some embodiments, the radiators 110 are corresponded to the radiators 310. In other words, a number of the radiators 110, a number of the radiators 310, and a number of the through holes 210 are equal to each other.

The radiators 110 are configured to receive the intermediate radio wave Wi and radiate the output radio wave Wo according to the intermediate radio wave Wi. The output radio wave Wo is transmitted through the body of the top printed circuit board 100. Because the metal frame 200, the intermediate radio wave Wi is confined within the through holes 210. More specifically, the intermediate radio wave Wi is transmitted from the radiators 310 to the radiators 110 through the through holes 210 without being interfered by other radio wave external to the through holes 210. In some embodiments, the output radio wave Wo and the intermediate radio wave Wi have substantially the same bandwidth.

In some embodiments, there are air existed in the through holes 210. Therefore, the metal frame 200 is also referred to as an air substrate.

It should be noted that the top printed circuit board 100 is the topmost element of the antenna device 10. Compared to the conventional arts which use the radome as the topmost element of an antenna device, the antenna device 10 do not include the conventional radome. Instead, the antenna device 10 has the top printed circuit board 100 disposed upside down. The top printed circuit board 100 is not only configured to radiate the output radio wave Wo but also cover the elements below from dust, rain, impact or strong light. Alternatively stated, the top printed circuit board 100 is also functioned as a radome.

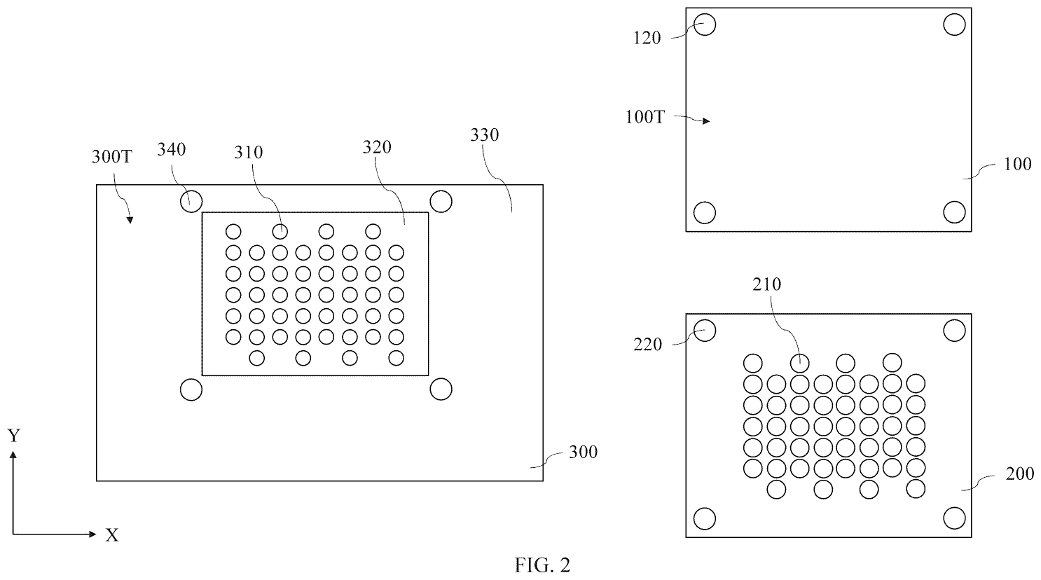

FIG. 2 is a schematic diagram of the top printed circuit board 100, the metal frame 200, and the stacked structure 300 from a top view according to some embodiments of the present disclosure. The perspective of the top view is viewing along the −Z direction, and perpendicular to a plane mutually defined by the X direction and the Y direction.

From the top view of the top printed circuit board 100, the top printed circuit board 100 does not include any electrical element on a top surface 100T of the top printed circuit board 100. The top printed circuit board 100 further include pilot holes 120. Each pilot hole 120 is extended through the top printed circuit board 100.

From the top view of the stacked structure 300, the stacked structure includes an antenna region 320 and a circuit region 330. The radiators 310 are disposed in the antenna region 320. In some embodiments, the radiators 310 are arranged as an array. The stacked structure 300 further include pilot holes 340. The pilot holes 340 are disposed in the circuit region 330 and near the antenna region 320.

From the top view of the metal frame 200, the through holes 210 are arranged as an array, and the array formed by the through holes 210 corresponds to the array formed by the radiators 310. When the metal frame 200 is in contact with the stacked structure 300, the through holes 210 circulates the radiators 310, respectively. The metal frame 200 further include pilot holes 220. Each pilot hole 220 is extended through the metal frame 200.

The pilot holes 120, the pilot holes 220, and the pilot holes 340 are configured to receive the fixtures 500.

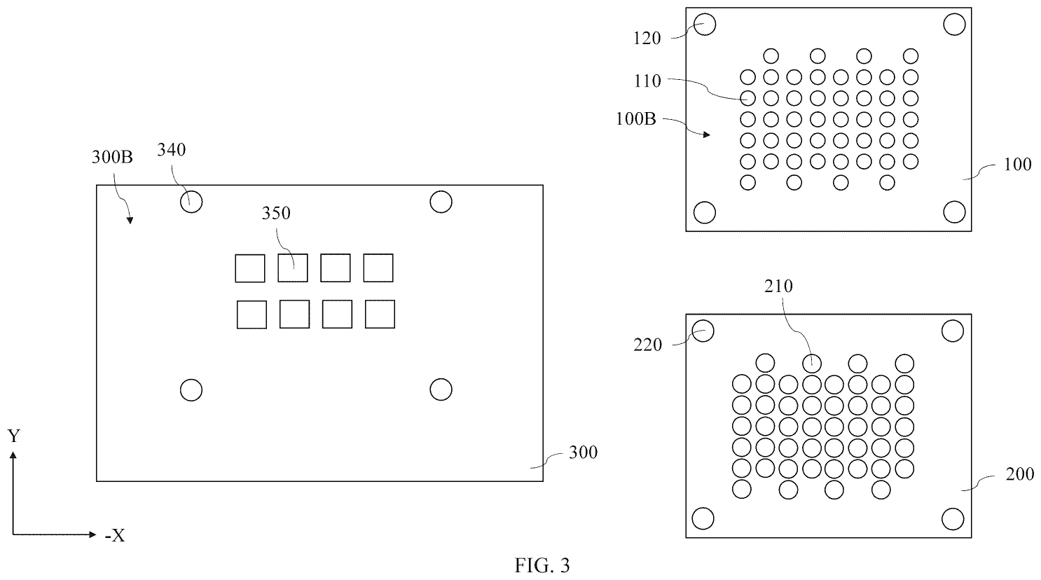

FIG. 3 is a schematic diagram of the top printed circuit board 100, the metal frame 200, and the stacked structure 300 from a bottom view according to some embodiments of the present disclosure. The perspective of the bottom view is viewing along the Z direction, and perpendicular to a plane mutually defined by the X direction and the Y direction.

From the bottom view of the top printed circuit board 100, the radiators 110 are arranged as an array, and the array formed by the radiators 110 corresponds to the array formed by through holes 210.

From the bottom view of the stacked structure 300, the stacked structure 300 includes beamforming integrated circuits 350 dispose on a bottom surface 300B of the stacked structure 300. The beamforming integrated circuits 350 are electrically coupled to the radiators 310 through internal connection of the printed circuit boards of the staked structure 300. In some embodiments, the stacked structure 300 may include other elements disposed on the bottom surface 300B.

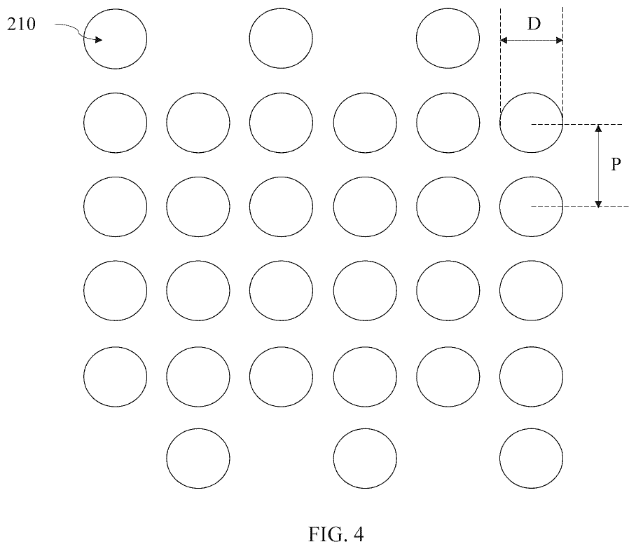

FIG. 4 is a schematic diagram of the through holes 210 of the metal frame 200 according to some embodiments of the present disclosure. For the sake of brevity, only a portion of through holes 210 are illustrated in FIG. 4.

In some embodiments, the through holes 210 are circle form the top view. A diameter D of the through hole 210 is equal to half of a wavelength of the output radio wave Wo transmitted in the top printed circuit board 100. In some embodiments, the diameter D is about 3.8 mm.

In some embodiments, a pitch P between two nearest through holes 210 is about 0.48 times of a wavelength of the intermediate radio wave Wi transmitted in free space. In some embodiments, the pitch P is about 5.23 mm.

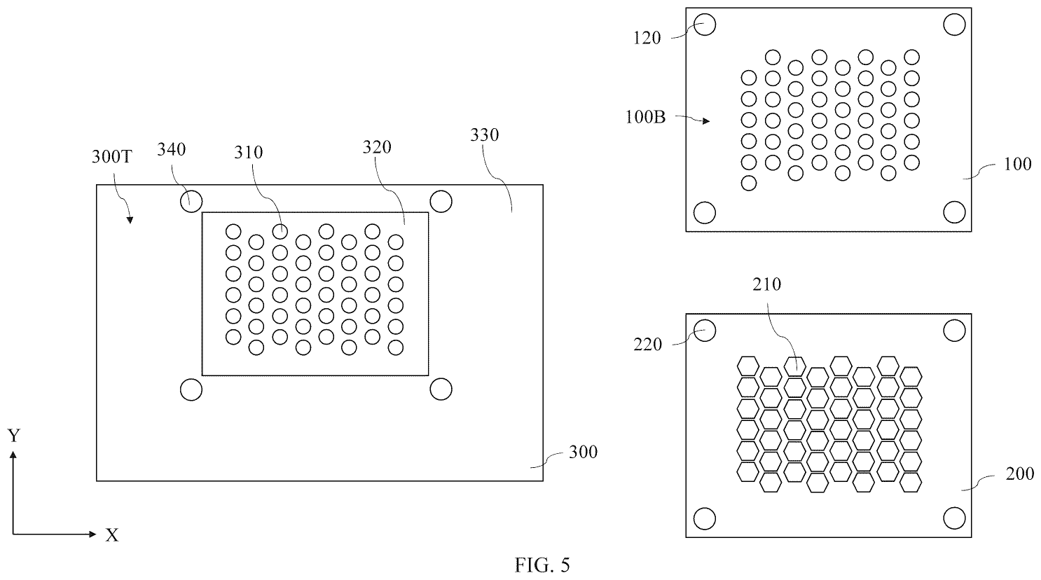

Although the through holes 210 are illustrated to have circular shape from the top view, the present disclosure is not limited thereto. The through holes 210 may have other shape from the top view. In other embodiments as illustrated in FIG. 5, the through holes 210 are hexagon from the top view.

In FIG. 5, the through holes 210 are arranged in columns, in which the columns are extended along the Y direction. Each column of through holes 210 is misaligned with the adjacent column of through holes 210. More specifically, each through hole 210 is interposed with a through hole 210 in the adjacent column.

Because the radiators 310 and the radiators 110 correspond to the through holes 210, the arrangements of the radiators 310 and the radiators 110 are similar to the arrangement of the through holes 210. Namely, the radiators 110 are arranged in columns, and each radiator 110 is interposed with a radiator 110 in the adjacent column. Similarly, the radiators 310 are arranged in columns, and each radiator 310 is interposed with a radiator 310 in the adjacent column.

In some embodiments, when the radiators 310 are arranged as an array (such as the arrangement shown in FIG. 2 and FIG. 3), the intermediate radio wave Wi is excited vertically (the polarization of the intermediate radio wave Wi is perpendicular to the top surface 300T). In some embodiments, when the radiators 310 are arranged in interposed columns (such as the arrangement shown in FIG. 5), the intermediate radio wave Wi is excited with an included angle equal to 45 degree between the top surface 300T and the polarization of the intermediate radio wave Wi.

In some embodiments, when the intermediate radio wave Wi is excited with the included angle equal to 45 degree, the frequency response of the horizontal polarization and the vertical polarization of the output radio wave Wo can be more similar.

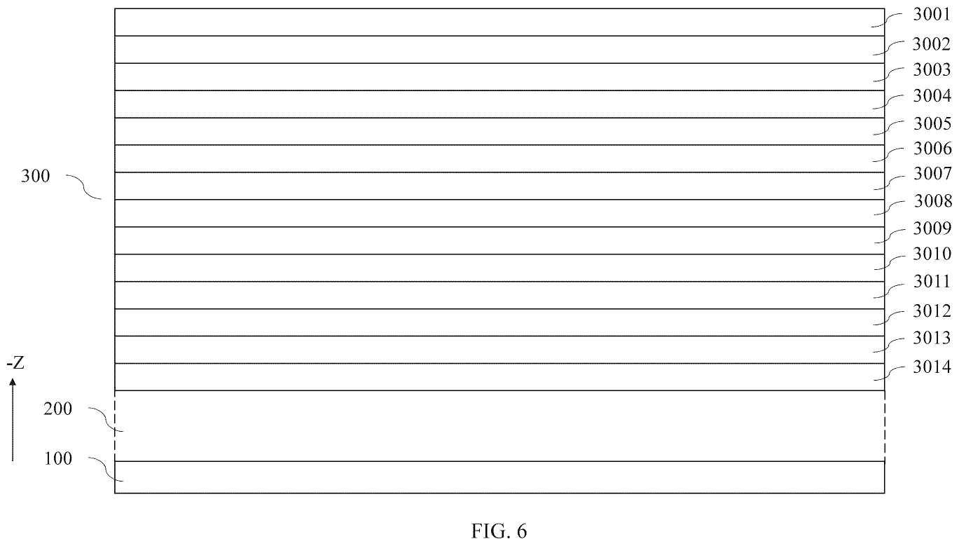

FIG. 6 is a schematic diagram of the stacked structure 300 according to some embodiments of the present disclosure. The stacked structure 300. The stacked structure 300 includes printed circuit boards stacked disposed, and these printed circuit boards includes a layer 3001, layer 3002, a layer 3003, a layer 3004, a layer 3005, a layer 3006, a layer 3007, a layer 3008, a layer 3009, a layer 3010, a layer 3011, a layer 3012, a layer 3013, and a layer 3014.

Each of the layer 3001 to the layer 3014 includes a base and an element layer on the base. In some embodiments, the bases of the layers 3001 to 3014 have the same thickness. In some embodiments, the thickness of the base is about 3±0.8 mils (≈0.0762±0.0203 mm).

In some embodiments, the element layers of the layer 3001 and the layer 3002 include radio frequency (RF) elements. In some embodiments, the element layers of the layer 3003 and the layer 3007 are connected to the ground. In some embodiments, the element layers of the layer 3004 to the layer 3006 include power elements. In some embodiments, the element layers of the layer 3008 to the layer 3012 include RF elements and a connection to the ground. In some embodiments, the element layer of the layer 3013 is connected to the ground. In some embodiments, the element layer of the layer 3014 includes RF elements, such as the radiators 310.

In some embodiments, the layer 3012 is connected to a feeder of the antenna device 10. In some embodiments, the layer 3013, the layer 3014, the metal frame 200, and the top printed circuit board 100 are collective to be operated as an antenna structure.

In some embodiments, the stacked structure 300 includes more than 14 printed circuit boards. In other embodiments, the stacked structure 300 includes less printed circuit boards, such as 8 printed circuit boards.

One aspect of the present disclosure provides an antenna device configured to transmit an output radio wave to other electronic device. The antenna device includes a stacked structure and a top printed circuit board. The stacked structure includes first radiators. The first radiators are configured to radiate an intermediate radio wave, and disposed on a top surface of the stacked structure. The top printed circuit board includes second radiators. The second radiators are configured to receive the intermediate radio wave and radiate the output radio wave according to the intermediate radio wave, and disposed on a bottom surface of the top printed circuit board. The bottom surface of the top printed circuit board is facing the top surface of the stacked structure.

Another aspect of the present disclosure provides an antenna device configured to transmit an output radio wave to other electronic device. The antenna device includes a stacked structure, a metal frame, and a top printed circuit board. The stacked structure is configured to radiate an intermediate radio wave. The metal frame is disposed on and in contact with a top surface of the stacked structure. The top printed circuit board is in contact with the metal frame and opposite to the stacked structure, and configured to receive the intermediate radio wave and radiate the output radio wave according to the intermediate radio wave.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, and steps.

What is claimed is:

1. An antenna device, configured to transmit an output radio wave to other electronic device, comprising:
a stacked structure, comprises:
a plurality of first radiators, configured to radiate an intermediate radio wave, disposed on a top surface of the stacked structure; and
a top printed circuit board, comprising:
a plurality of second radiators, configured to receive the intermediate radio wave and radiate the output radio wave according to the intermediate radio wave, disposed on a bottom surface of the top printed circuit board, wherein the bottom surface of the top printed circuit board is facing the top surface of the stacked structure.

2. The antenna device of claim 1, further comprising:
a metal frame, disposed between the stacked structure and the top printed circuit board, comprising a plurality of through holes.

3. The antenna device of claim 2, wherein the metal frame is in contact with the top surface of the stacked structure and the bottom surface of the top printed circuit board, wherein each of the plurality of the through holes exposes one of the plurality of first radiators and one of the plurality of second radiators.

4. The antenna device of claim 3, wherein the intermediate radio wave is transmitted from the plurality of first radiators to the plurality of second radiators through the plurality of through holes.

5. The antenna device of claim 2, wherein the metal frame is free in contact with the plurality of first radiators and the plurality of second radiators.

6. The antenna device of claim 2, wherein the plurality of through holes are arranged as an array from a top view.

7. The antenna device of claim 2, wherein each of the plurality of through holes is a hexagon from a top view.

8. The antenna device of claim 2, wherein a diameter of each of the plurality of through holes is equal to half of a wavelength of the output radio wave transmitted in the top printed circuit board.

9. The antenna device of claim 2, wherein a pitch between two nearest through holes is about 0.48 times of a wavelength of the intermediate radio wave transmitted in free space.

10. The antenna device of claim 2, wherein a thickness of the metal frame is about 0.8 mm.

11. The antenna device of claim 1, wherein the stacked structure comprises a plurality of printed circuit boards stacked disposed,
wherein each of the plurality of printed circuit boards has a thickness substantially the same to each other.

12. An antenna device, configured to transmit an output radio wave to other electronic device, comprising:
a stacked structure, configured to radiate an intermediate radio wave;
a metal frame, disposed on and in contact with a top surface of the stacked structure; and
a top printed circuit board, in contact with the metal frame and opposite to the stacked structure, configured to receive the intermediate radio wave and radiate the output radio wave according to the intermediate radio wave.

13. The antenna device of claim 12, wherein the metal frame comprises a plurality of through holes, wherein the intermediate radio wave is transmitted from the stacked structure to the top printed circuit board through the plurality of through holes.

14. The antenna device of claim 13, wherein the stacked structure comprises a plurality of first radiators,
wherein the plurality of first radiators are disposed on the top surface of the stacked structure and configured to radiate the intermediate radio wave.

15. The antenna device of claim 14, wherein the top printed circuit board comprises a plurality of second radiator,
wherein the plurality of second radiator are disposed on a bottom surface of the top printed circuit board configured to receive the intermediate radio wave so as to radiate the output radio wave,
wherein the bottom surface of the top printed circuit board is in contact with the metal frame.

16. The antenna device of claim 15, wherein the plurality of through holes expose the plurality of first radiators and the plurality of second radiators, and the plurality of first radiators and the plurality of second radiators are free in contact with the metal frame.

17. The antenna device of claim 13, wherein each of the plurality of through holes is circle from a top view.

18. The antenna device of claim 13, wherein each of the plurality of through holes is hexagon from a top view.

19. The antenna device of claim 12, wherein the stacked structure comprises 14 layers of printed circuit boards stacked disposed.

20. The antenna device of claim 12, wherein the metal frame includes aluminum.
